(19) United States
(12) Patent Application Publication
(10) Pub. No.: US 2017/0356588 A1
(43) Pub. Date: Dec. 14, 2017

(54) CORROSION PREVENTION CONNECTOR FOR POTABLE WATER PIPING SYSTEMS

(71) Applicant: Frank Gaunce, Romeoville, IL (US)

(72) Inventor: Frank Gaunce, Romeoville, IL (US)

(21) Appl. No.: 15/177,770

(22) Filed: Jun. 9, 2016

(51) Int. Cl. F16L 58/18

(52) U.S. Cl. CPC F16L 58/18

(57) ABSTRACT

Provided is a corrosion prevention connector for preventing corrosion and pinhole leaks in potable water copper or lead piping systems. A length of copper, iron, or lead pipe is surrounded by a galvanize made of a metal or metal alloy less noble than, e.g., iron alloy, zinc, aluminum, magnesium, titanium, and/or alloys thereof. The galvanize is metallurgically attached to the length of copper or lead pipe. When the corrosion prevention connector is electrically attached to the copper or lead piping systems at one end and attached to a plastic (or other non-electrically conductive material) main or lateral at the other end, the potable water copper or lead piping system is maintained at a potential above the cathodic redox reaction potential of the chemical reaction between copper or lead pipes and the purification chemicals contained in the potable water. Thus, preventing the internal pipe corrosion and pinhole leeks caused by the redox chemical reaction between the pipe interior and the protective concentration of purification chemicals intentionally left in the purified drinking water. The connector also acts as a sacrificial anode to protect the exterior of the pipe from corrosion.

### TECHNICAL FIELD

This disclosure relates generally to systems and methods for preventing corrosion in potable water distribution systems using copper or lead pipes supplied by plastic mains and/or laterals rather than iron pipe.

### BACKGROUND

Construction of water systems using iron piping for mains and distribution laterals is a long and well established practice. Copper and lead piping has long been the preferred construction material for domestic and facility potable water distribution systems. This preference was because of copper's and lead's:
resistance to corrosion
ease of fabrication
long, reliable service life
pressure resistance
temperature resistance
anti-bacterial and anti-fungal properties
non-flammability
ready availability; and
reasonable cost

Copper and lead plumbing systems were connected directly to the iron pipe. However, it is well known that lead is toxic if ingested. Because iron is anodic to copper and lead, the iron piping acted as a sacrificial anode to the copper and/or lead piping, thus protecting the copper piping from corrosion.

More recently, plastic has been developed and made readily available in many forms. Plastic has many desirable characteristics, including:
corrosion resistance
moderate temperature and pressure resistance
relatively light weight
flexibility
toughness
ease of joining, and
relatively low cost

but plastic lacks many desirable characteristics of iron, copper, and lead such as: electrical conductivity, higher pressure and temperature resistance, non-flammability, resistance to punctures, and anti-bacterial and anti-fungal properties, making plastic piping an acceptable alternative for use in only some potable water systems at lower temperatures and pressures. A change from iron to plastic removes the iron sacrificial anode that protects the copper and lead piping from corrosion by the potable water. The recent occurrence of interior corrosion, causing pinhole leaks in copper piping systems, is the result of this substitution of plastic pipe for the traditionally-used iron pipe. Also, the use of plastic pipe and other plastic components to repair ageing iron and lead potable water distribution systems has disrupted the electrical continuity between the various metal components of the systems. This has allowed the interior of lead pipe(s) to corrode and contaminate the drinking water with soluble lead. The interior surface corrosion is caused by the chemical redox reaction between the disinfecting chemicals used to produce the potable water and the copper and lead pipes. Water turbulence provides the activation energy needed to initiate the redox reaction and, consequently, sites where turbulence occurs tend to be the location of corrosion and pinhole leaks.

To produce potable water, particulate free raw water is treated with oxidizing chemicals such as chlorine gas and/or hydrogen peroxide to destroy pathogens harmful to health. These reagents are normally added in stoichiometric excess to provide a reserve for additional purification should the potable water become contaminated during delivery. The concentrations of these purification chemicals remaining in the potable water are not great enough cause a spontaneous redox reaction at room temperature with the inside surface of the copper pipe without the introduction of energy from an outside source such as turbulent fluid flow, sound, mechanical vibration, etc. These chemicals do not cause general corrosion of the pipe interior surface when the water flow is laminar and not turbulent because not enough energy is generated by the laminar fluid flow to satisfy the activation energy needed to initiate the redox reaction. A higher temperature reduces the amount of activation energy required to initiate the redox reaction, possible allowing for a spontaneous corrosion reaction at comparable potentials.

When water flow is turbulent the corrosion becomes more random resulting in a rough surface. When turbulence is caused by high flow, pipe joints, rough surface, severe directional change as in a 90 degree elbow, solder prills, etc. Vortices and eddies form on the down stream side of these irregularities. These vortices create energy and cause bubbles enriched with the purification chemicals. The bubbles accumulate in the stationary eddies where the turbulence-created energy supplies the necessary activation energy to initiate an anodic chemical redox reaction between the disinfectant chemicals and the interior of the copper pipe. In the case of copper pipes, this creates a pit in the pipe wall. This redox reaction can continue until the pipe wall is penetrated, producing a pinhole leak. This explains why pipe corrosion tends to be located down flow of surface irregularities and the location of pin leaks.

The localized redox chemical reactions between the copper pipe and the protective disinfectants that cause the pinholes will now be explained. When the necessary reactants are present in sufficient concentration, the system is at or beyond the reaction's oxidation potential, and enough activation energy is present, a corrosion reaction ensues. When the copper pipe is one of the reactants it is corroded removing some of the metal as a copper ion. The cuprous copper ion reacts excess chlorine left in the purified water exiting the purification plant to produce cuprous chloride and cuprous oxide and/or cuprous-oxychloride precipitate. This cuprous precipitate acts as a catalyst to allow the corrosion reaction to go on to completion, resulting in penetration of the pipe wall. Some of the precipitate is carried downstream where it is deposited on the pipe wall creating a blue/green stain of corrosion products on the pipe interior. The remainder is dissolved in the flowing water. Electrons are exchanged between the participating chemical elements in this redox reaction but no external electrical current is generated, as is the case with electrolytic reactions involving a sacrificial anode with copper or lead as cathode. The reaction with the lead pipe is similar to that with a copper pipe. The big difference is that the lead corrosion contaminates the drinking water with soluble toxic lead.

The iron pipe acting as a sacrificial anode protecting the copper and lead plumbing from corrosion was an untended consequence of using iron pipe. The iron pipe was sacrificial in that it supplied electrons to the cathodic electrolytic reaction, that protected the lead and/or copper plumbing from corrosion.

In the context of controlling the redox reaction causing the internal surface corrosion of the copper plumbing, the iron pipe acting as a “sacrificial” anode did not corrode to provide electrons to the redox reaction, but raised the cathodic potential of the copper and/or lead, thus causing the redox reaction with them to be cathodic, and thus preventing the corrosion of the interior surface of the copper and lead pipes. Isolated copper and lead, in the context of their redox reactions with the disinfecting chemicals, are at potentials that cause their redox reactions to be anodic, thus causing the copper and lead metals to be corroded. The chemical function of the iron pipe anode is to raise the potential of the copper and/or lead to the cathodic potentials of their redox reactions, thus preventing the corrosion of the copper and lead pipe interiors, but otherwise it does not participate in the redox reaction that corrodes the interior of pipes. The iron pipe is a source of potential chemical energy.

### SUMMARY

The present invention reverses the corrosive action of the redox reactions—the protective concentration of purification chemicals and the copper and lead piping by increasing the potential of the copper and lead pipes to at least their reduction potentials of their redox reaction thereby preventing the corrosive chemical reaction with the copper and lead plumbing.

The potential of the redox reaction is raised to the reduction (cathodic) potential by attaching a grounded sacrificial anode, made of a metal less noble than copper, such as iron, zinc or other less noble metal or metal alloy, with an electrical conductor. Alternately the reduction potential can be raised by attaching the negative terminal of a grounded independent DC power source to the copper or lead pipe. This prevents the interior corrosion of the copper and lead pipe by the redox chemical reaction between the disinfectant chemicals and the interior of the copper and lead pipe systems.

Because the anode and the copper and lead pipes share an electrolytic connection through the ground, the sacrificial anode and copper and lead pipes form electrolytic cells which potentially can generate an electrical current that corrodes the sacrificial anode and prevents corrosion of the copper and lead cathodes.

The interior surfaces of the cathode are not electrolytically protected from corrosion by the cathodic corrosion prevention system because the interior surface does not have an anode to complete an electrolytic cell. In the case of the pinhole development in copper pipe due to interior corrosion said corrosion is caused by a redox chemical reaction between solution chemicals and the pipe interior. Similarly, in the case of interior corrosion of lead pipe it is caused by the chemical redox reaction between the lead pipe and the excess purification chemical in the potable water and the lead pipe. There is no electrical current flow generated between the sacrificial anode and the copper and lead pipes. The purpose of the sacrificial anode is to raise the potential of the copper and lead systems to, or above, the cathodic potential of the redox reaction between the potable water and the copper and lead. The sacrificial anode does not provide an electrical current to drive the redox reaction. The pipe metal potential determines whether the redox reaction is anodic or cathodic. The required energy of reaction is derived from the internal energy of the reacting chemicals. The activation energy required to initiate the reaction is derived from an outside source such as; turbulent fluid flow, heat, vibration, mechanical shock, ultrasound, etc. Once the reaction is initiated it tends to continue until the reactants are consumed.

The present invention comprises electrically attaching a dedicated passive cathodic corrosion prevention system to the potable water copper and lead piping systems. The passive cathodic corrosion prevention system comprises a metal or metal alloy sacrificial anode with a standard reduction potential greater than that of copper and lead. Less noble metals such as iron, zinc, aluminum, magnesium, titanium, and alloys thereof may also be used to protect various other metal components connected to the plumbing system from corrosion.

As an alternative to a passive cathodic corrosion prevention system an active cathodic corrosion prevention system may be used. The active cathodic corrosion protection system comprises an independent source of DC power, a voltage controller and a non-sacrificial grounding anode. The negative terminal of the voltage controller is connected to the potable water copper and lead piping systems. The systems are maintained at a voltage at or above the reduction potentials of copper and lead.

The methods and systems disclosed herein protect the exterior lead and/or copper surfaces from chemical corrosion by making the copper and lead surfaces a cathode of an electrolytic which is held above the reduction potentials of elemental copper and lead. These methods and systems protect the interior surfaces of the copper and lead pipes by maintaining the interior surface potential of the pipe above the reduction potential of the redox chemical reaction between the pipe interior surfaces and the excess disinfectant chemicals used to prepare and protect the potable water.

### BRIEF DESCRIPTION OF DRAWINGS

Embodiments are illustrated by way of example and not limitation in the figures of the accompanying drawings, in which like references indicate similar elements and in which:

FIG. 1 illustrates a corrosion prevention connector according to one embodiment of the invention.

FIG. 2 illustrates an example copper pipe potable water system in which the corrosion prevention connector may be used.

FIG. 3 illustrates a corrosion prevention connector connected to a plumbing system and supply line according to another embodiment of the invention.

### DETAILED DESCRIPTION

The following detailed description includes references to the accompanying drawings, which form a part of the detailed description. The drawings show illustrations in accordance with example embodiments.

The systems and methods disclosed herein for preventing corrosion of copper and lead piping and the prevention of copper pipe pin holes comprise electrically attaching a dedicated cathodic corrosion protection system to the copper, and lead, potable water piping systems. The passive cathodic corrosion protection system may be composed of a sacrificial anode made of a metal or metal alloy, which is less noble than copper or lead. The anode is in contact with the ground and electrically connected to the copper or lead pipe system. The sacrificial anode maintains the copper or lead piping system at a voltage above the reduction potentials of copper and lead in the potable water environment, thus making the redox chemical reaction between the copper and lead pipes and the potable water cathodic, and thus preventing the interior corrosion of the copper and lead piping systems.

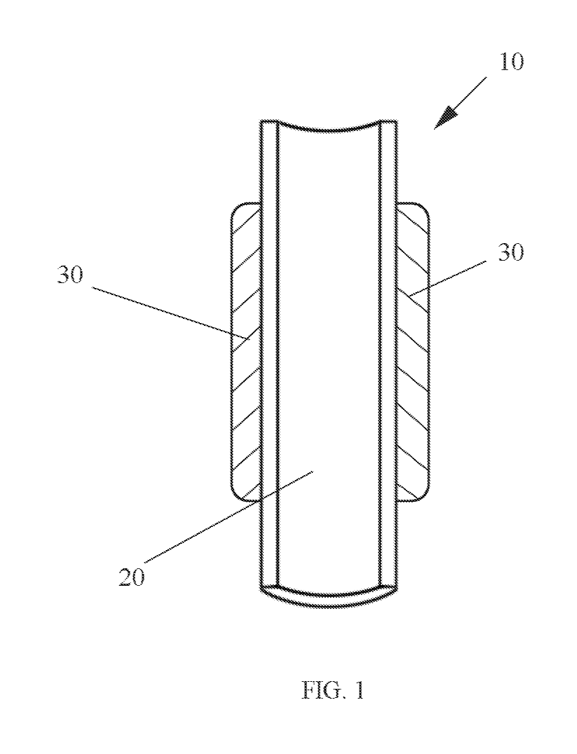

FIG. 1 shows an example of a corrosion prevention connector 10 according to the principles of the present invention. Copper pipe 20 is shown in cross-section. Galvanize 30 surrounds a section of copper pipe 20, leaving bare copper at the top and bottom of copper pipe 20. Galvanize 30 may be made of a metal or metal alloy less noble and/or more reactive than copper, e.g., a metal or metal alloy such as iron, zinc, aluminum, magnesium, titanium, or alloys thereof. One of ordinary skill in the art will recognize other materials that may be used. Iron metal may be used for more benign conditions, but zinc, aluminum alloy, magnesium, or titanium may be required for more electrically resistant grounding medium and/or larger area piping systems. The pipe 20 may also be comprised of iron rather than copper. One of ordinary skill in the art will understand that the metal core of copper pipe 20 may be iron rather than copper.

One end of connector 10 electrically connects to existing copper and/or lead plumbing, using any standard method known to those of ordinary skill in the art. The other end of connector 10 connects to the plastic or other non-electrically conducting material supply line by standard trade practice. When properly connected, galvanize 30 maintains the copper and/or lead piping systems at a voltage above the reduction potentials of copper and lead, thus preventing the interior corrosion of the copper and lead piping systems by making the redox chemical reaction potential with the potable water cathodic. The interior of copper or iron pipe 20 may be clean bare copper, or iron, free of any galvanize, to avoid contamination of the potable water.

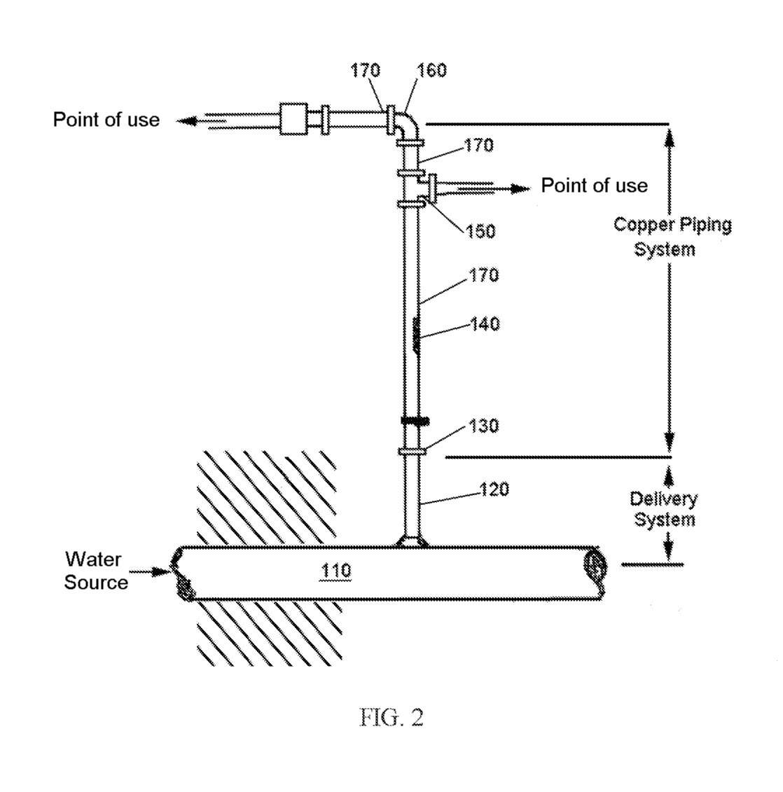

FIG. 2 shows an example of a copper pipe potable water system in which the corrosion prevention connector may be used. Plastic main 110 provides potable water from a water source. Plastic lateral 120 provides water from plastic main 110 to a copper piping system at a point of use through service connection 130. The delivery system is comprised of plastic main 110 and plastic lateral 120, and is generally underground, as indicated by the cross hatches. Note that, for clarity, only a portion of the ground is shown crosshatched. It should be understood that the corrosion prevention connector may act as the service connection 130. In addition, the galvanized portion of the corrosion prevention connector is grounded. Further, a section of lead pipe may lay between the corrosion prevention connector and the copper or iron plumbing.

Water flows through the copper plumbing system, past solder prill 140, soldered tee 150, and soldered 90 degree elbow 160, creating turbulence at points 170. In past copper piping systems, these turbulent flow points would have provided the activation energy required to initiate a redox reaction between the copper pipes and the potable water; however the iron mains and laterals raised the potential of the copper to the level where the Redox reaction became cathodic, so that corrosion did not occur near the turbulent flow points. Note that solder prill 140, soldered tee 150, and soldered 90 degree elbow 160 are exemplary components of the system, and are only used to explain where turbulence may occur. Any number of these components, from none to many, may be present in the system.

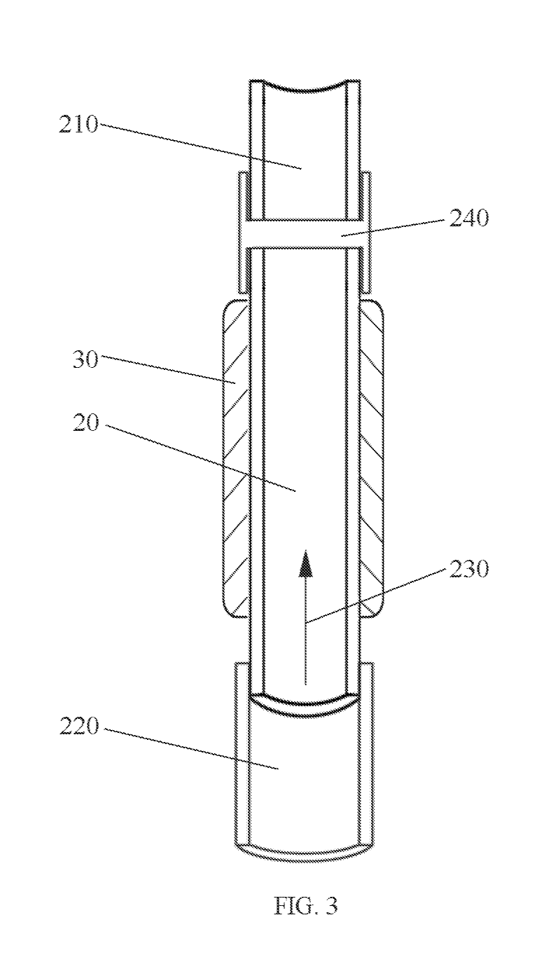

FIG. 3 shows corrosion prevention connector 10 connected to the copper or lead plumbing and plastic supply line. Copper or iron pipe 20, with galvanize 30 surrounding it, is connected to copper, or lead, plumbing 210 and plastic pipe 220. Flow arrow 230 shows the flow of the potable water. Metallic coupling 240 electrically connects copper or iron pipe 20 to copper or lead plumbing 210. Copper pipe 20 and copper plumbing 210 may be sized to fit a standard soldered coupling. Alternatively, the metallic coupling 240 may be a reducer to accommodate pipes of different diameters. Copper pipe 20 may be of a gauge and diameter to fit with copper plumbing 210.

At the other end of copper or iron pipe 20, plastic pipe 220 is fitted to copper pipe 20 using a metallic or non-metallic coupler or any standard method known to one of ordinary skill in the art, e.g., a clamp. Plastic pipe 220 and copper pipe 20 may have common diameters to promote laminar fluid flow.

Galvanize 30 is in contact with the ground medium, e.g., soil. The ground medium provides the electrical return leg of the electrolytic circuit when the connector is acting as a sacrificial anode to protect the exterior of the copper or lead pipe. Further, it acts to protect the iron components to which it is electrically connected. The required length and thickness of galvanize 30 depends upon project requirements, such as the area and the size of the copper piping system, the location of the corrosion prevention connector, and the desired service life of the galvanize. Multiple corrosion prevention connectors 10 may my connected in tandem depending on project requirements. The inside diameter of the core pipe 20 and pipe wall thickness shall comply with project specifications.

Although the invention has been described in terms of particular embodiments, one of ordinary skill in the art, in light of the teachings herein, will be able to generate additional embodiments and modifications without departing from the spirit of, or exceeding the scope of, the claimed invention. This invention is not limited to using the particular elements, materials, or components described herein, and other elements, materials, or components will be equivalent for the purposes of this invention. Accordingly, it is understood that the drawings and the descriptions herein are proffered only to facilitate comprehension of the invention and should not be construed to limit the scope thereof.

What is claimed is:

1. A corrosion prevention connector for a potable water piping system, wherein the potable water piping system comprises non-conductive mains and/or laterals and a piping system, the piping system comprising an intake pipe, the corrosion prevention connector comprising:
a. a pipe sized to fit a non-conductive main and/or lateral at a first end and sized to fit the intake pipe at a second end;
b. a galvanize surrounding a portion of the copper pipe; and
c. whereby the pipe is comprised of lead, iron, or copper.

2. The corrosion prevention connector of claim 1, wherein the galvanize is comprised of a metal less noble than copper.

3. The corrosion prevention connector of claim 2, wherein the galvanize is comprised of iron, zinc, aluminum, magnesium, titanium, or an alloy thereof.

4. The corrosion prevention connector of claim 1, wherein the non-conductive main and/or lateral is comprised of plastic.

5. The corrosion prevention connector of claim 1, wherein the piping system is maintained at a voltage above the reduction potential of copper when the first end of the corrosion prevention connector is connected to the non-conductive main and/or lateral and the second end of the corrosion prevention connector is electrically connected to the intake pipe.

6. The corrosion prevention connector of claim 1, wherein the piping system is comprised of copper or lead.

7. A corrosion prevention potable water system, comprising:
a. at least one non-conductive main and/or lateral,
b. a piping system,
c. a corrosion prevention connector electrically connected to the piping system and connected to the at least one non-conductive main and/or lateral, wherein the corrosion prevention connector comprises:
1. a pipe;
2. a galvanize surrounding a portion of the copper pipe;
3. wherein the pipe is comprised of copper, iron, or lead.
d. whereby potable water flows from the at least one non-conductive main and/or lateral through the corrosion prevention connector and into the piping system;
e. a plurality of water purification chemicals;
f. a cathodic redox reaction potential between the plurality of water purification chemicals and the corrosion prevention connector;
g. whereby the piping system is comprised of copper or lead; and
h. whereby the piping system is maintained at a voltage above the cathodic redox reaction potential between the plurality of water purification chemicals and the corrosion prevention connector.

8. The corrosion prevention connector of claim 6, wherein the galvanize is comprised of a metal less noble than iron.

9. The corrosion prevention connector of claim 7, wherein the galvanize is comprised of iron, zinc, aluminum, magnesium, titanium, or an alloy thereof.

10. The corrosion prevention connector of claim 6, wherein the non-conductive main and/or lateral is comprised of plastic.

11. The corrosion prevention connector of claim 6, further comprising a second corrosion prevention connector connected between the piping system and ground.
